(19) United States
(12) Patent Application Publication
(10) Pub. No.: US 2004/0119703 A1
(43) Pub. Date: Jun. 24, 2004

(54) Stylus ejection mechanism for a portable computer

(76) Inventors: Kuo-Chang Yang, Hsinchu (TW); Shih-Hwa Lan, Yunlin Shien (TW)

Correspondence Address: RABIN & BERDO, P.C., Suite 500, 1101 14 Street, N.W., Washington, DC, 20005, US

(21) Appl. No.: 10/426,875

(22) Filed: May 1, 2003

(30) Foreign Application Priority Data
Dec. 18, 2002 (TW) 91220578

(51) Int. Cl. G09G 5/00

(52) U.S. Cl. 345/179

(57) ABSTRACT

An ejection mechanism of a stylus in a portable computer is mounted on the bottom of the stylus slot. The stylus ejection mechanism comprises an elastic apparatus and a holder. The elastic apparatus fixed to the bottom of the stylus slot provides the ejection force for the stylus. The elastic apparatus can be a spring, a metal plate or a plastic arm. The holder provides a support for the stylus when it is inserted for storage.

### BACKGROUND OF THE INVENTION

1. Field of Invention

The present invention relates to a stylus ejection mechanism. More particularly, the present invention relates to a stylus ejection mechanism in a portable computer.

2. Description of Related Art

The desktop PC has evolved into a variety of computers, such as the notebook PC, pocket PC, PDA (Personal Digital Assistant, such as the Palm OS PDA), and other internet appliances. These computer devices, much smaller and thinner than the desktop PC, usually do not have keyboards or need extra keyboards for inputting data. Therefore, these computer devices usually provide a touch panel or other device for manual input. For example, a PDA may offer a writing pad and touch panel for launching or operating application programs.

Regardless of whether a writing pad or touch panel is employed, a stylus is essential for operation and input. The stylus of a PDA or Pocket PC is made of plastic or metallic materials, and does not include any electronic devices. Most PDAs provide slots for storing styluses.

However, a stylus of a complicated computer contains electronic devices. For example, a Tablet PC stylus has a battery or a coil built inside. Having electronic devices built inside a stylus not only enlarges the size thereof but also increases its weight. Thus, a user must exert more force to remove the stylus from the storage slot

### SUMMARY OF THE INVENTION

It is therefore an objective of the present invention to provide a stylus ejection mechanism for removing a stylus from the slot in a portable computer device.

In accordance with the foregoing and other objectives of the present invention, a stylus ejection mechanism installed in a bottom of a slot of a portable computer comprises an elastic apparatus having one end fixed to the bottom of the slot and a holder having one end fastened to the elastic apparatus. The stylus is inserted in an opening in the holder.

According to one preferred embodiment of present invention, the elastic apparatus is a spring providing pushing forces. One end of the spring is fixed to the bottom of a slot; the other is connected to a holder.

According to another preferred embodiment of present invention, the elastic apparatus is a metal elastic apparatus providing pushing forces. One end of the elastic apparatus is fixed to the bottom of a slot; the other is connected to a holder.

According to a further preferred embodiment of present invention, a fastening structure, an elastic apparatus and a holder are shaped together as a stylus ejection mechanism by plastic casting.

In light of the preferred embodiments of this invention, the stylus ejection mechanism is employed for easy removal of the stylus from the slot and prevents the stylus slipping out from the slot by engaging the same with the switch during storage.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a stylus slot position layout according to one preferred embodiment of this invention;

FIG. 1B illustrates a stylus ejection mechanism according to one preferred embodiment of this invention;

FIG. 2A illustrates a stylus ejection mechanism containing a spring according to one preferred embodiment of this invention;

FIG. 2B illustrates an exploded view of a stylus ejection mechanism containing a spring according to one preferred embodiment of this invention;

FIG. 3A illustrates a stylus ejection mechanism containing a metal elastic apparatus according to another preferred embodiment of this invention;

FIG. 3B illustrates an exploded view of a stylus ejection mechanism containing a metal elastic apparatus according to another preferred embodiment of this invention;

FIG. 4A illustrates a stylus ejection mechanism containing a plastic elastic apparatus according to further another preferred embodiment of this invention; and

FIG. 4B illustrates a stylus ejection mechanism made by plastic casting according to further another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

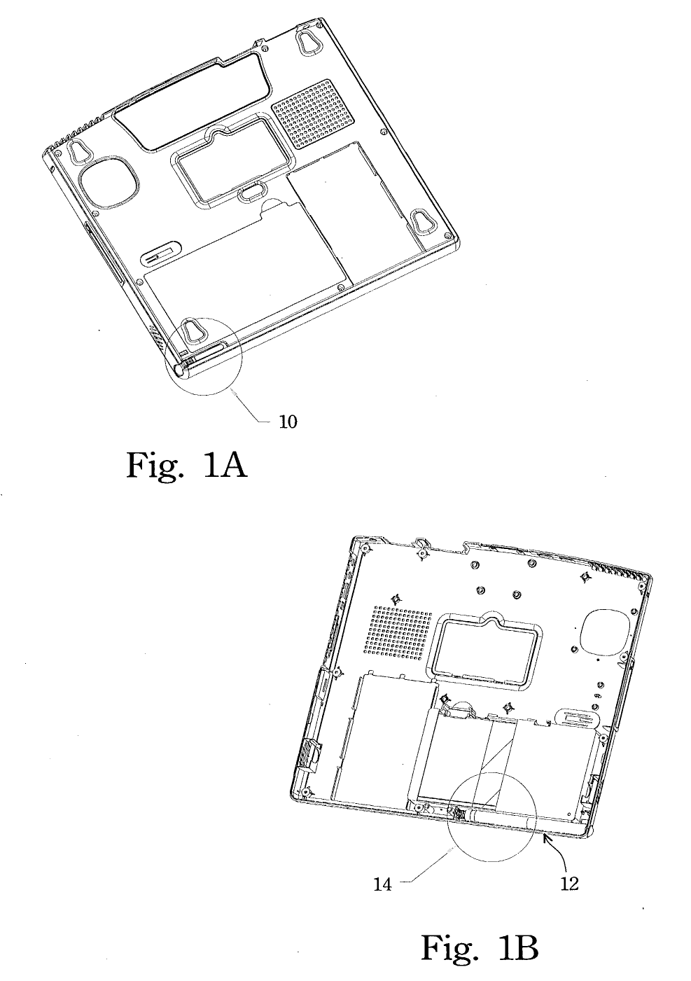

FIG. 1A illustrates a stylus slot position layout according to one preferred embodiment of this invention. The position of the stylus slot 10 can be in a mainframe portion of a portable computer (shown as FIG. 1A), or in a display portion. The portable computer mentioned above comprises Tablet PCs and Notebook PCs. Although the present invention has been described in considerable detail with reference to Notebook PCs, the scope of application should not be limited thereto to the description of the preferred embodiments. A switch is essential for stylus slot 10 to prevent a stylus 12 from slipping out. In addition to the switch, an ejection mechanism is also used to remove easily a stylus from the slot. FIG. 1B illustrates a stylus ejection mechanism 14 according to one preferred embodiment of this invention. The present invention focuses on mechanism design and selection of materials for the stylus ejection mechanism.

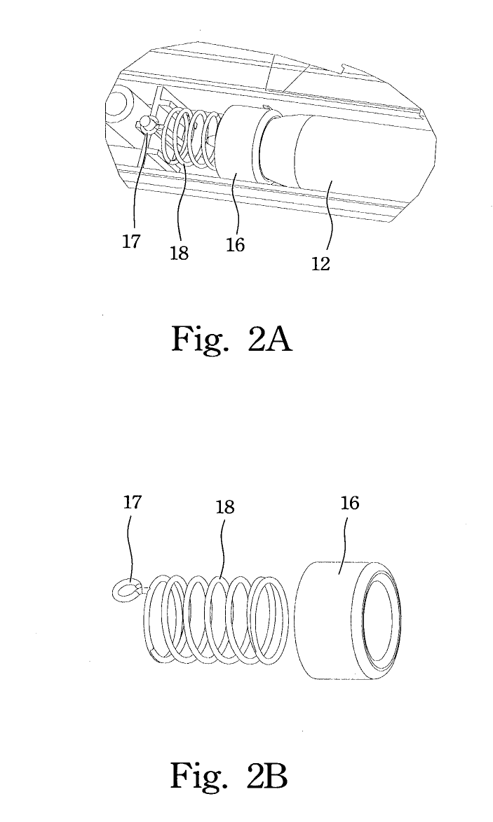

FIG. 2A illustrates a stylus ejection mechanism 14 containing a spring 18 according to one preferred embodiment of this invention. FIG. 2B illustrates an exploded view of a stylus ejection mechanism containing a spring according to one preferred embodiment of this invention. The stylus ejection mechanism comprises a fastening structure 17, an elastic apparatus 18, and a holder 16. The elastic apparatus 18 is preferred a spring. The fastening structure 17 is an annulus made from one shaped end of spring 18. One end of the spring 18 is clamped or bolted to the bottom of the slot by the fastening structure 17. The other end of the spring 18 is connected to the holder 16. The holder 16 is employed to support a stylus via an inserting part, such as an opening, in the center of the holder 16.

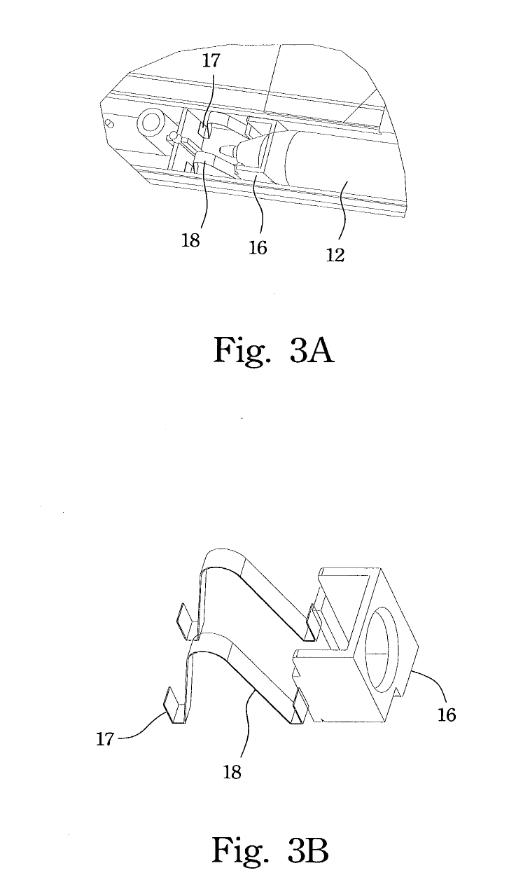

FIG. 3A illustrates a stylus ejection mechanism containing a metal elastic apparatus according to another preferred embodiment of this invention. FIG. 3B illustrates an exploded view of a stylus ejection mechanism containing a metal elastic apparatus according to another preferred embodiment of this invention. The stylus ejection mechanism comprises a fastening structure 17, anelastic apparatus 18, and a holder 16. The elastic apparatus 18 is preferred a V-shaped metal fragment. The fastening structure 17 is a hook made from one shaped end of metal elastic apparatus 18. One end of the metal elastic apparatus 18 is clamped or bolted to the bottom of the slot by the fastening structure 17. The other end of the metal elastic apparatus 18 is connected to the holder 16. The holder 16 is employed to support a stylus 12 via an inserting part, such as an opening in the center of the holder 16.

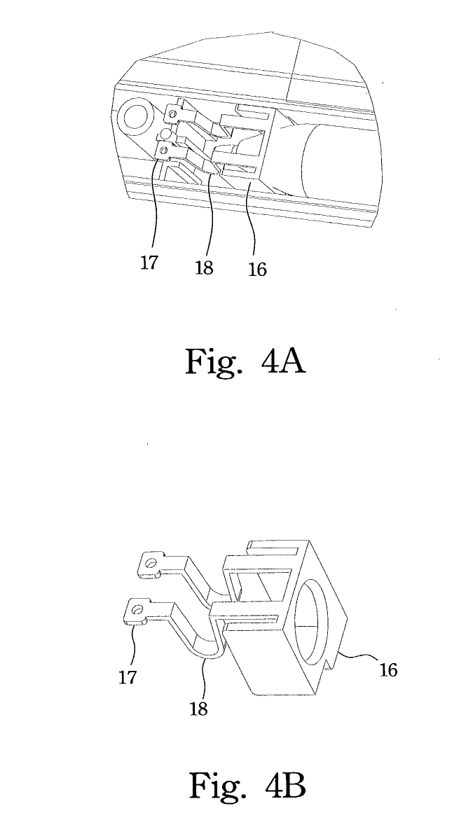

FIG. 4A illustrates a stylus ejection mechanism containing a plastic elastic apparatus according to further another preferred embodiment of this invention. FIG. 4B illustrates a stylus ejection mechanism made by plastic casting according to further another preferred embodiment of this invention. A fastening structure 17, an elastic apparatus 18, and a holder 16 are formed together in a single structure by plastic casting. The integrated fastening structure 17 is clamped or bolted to the bottom of the slot, and the holder 16 is also integrated. Thus, this embodiment of present invention can reduce mold design costs and assembly.

In practice, the stylus ejection mechanism is employed together with the switch mentioned above. When a stylus contacts the holder, a force is necessary to push the stylus until the switch can clamp the stylus. When a stylus is taken out, the switch is touched manually and the stylus is ejected out of the slot by the stylus ejection mechanism. The switch structure of the slot is not described in detail because it is not the point of this invention.

In light of the preferred embodiments of this invention, the stylus ejection mechanism is employed for easy removal of the stylus from the slot and prevents the stylus from slipping out the slot by engaging the same the switch during storage.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stylus ejection mechanism installed in a bottom of a slot of a portable computer device, said stylus ejection mechanism comprising:
an elastic apparatus, having one end fixed to said bottom of said slot, to provide a stylus ejecting force; and
a holder, having one end fastened to said elastic apparatus, and an inserting part for inserting a stylus.

2. The stylus ejection mechanism of claim 1, wherein said elastic apparatus further comprises a fastening structure.

3. The stylus ejection mechanism of claim 2, wherein said elastic apparatus is clamped or bolted to said bottom of said slot through said fastening structure.

4. The stylus ejection mechanism of claim 1, wherein said elastic apparatus is a spring providing pushing forces.

5. The stylus ejection mechanism of claim 1, wherein said elastic apparatus is a metal elastic apparatus providing pushing forces.

6. The stylus ejection mechanism of claim 1, wherein said elastic apparatus and said holder can be formed together as a whole by plastic casting.

7. A stylus ejection mechanism installed a portable computer device, said stylus ejection mechanism comprising:
a slot, installed in said portable computer device to store a stylus;
an elastic apparatus, having one end fixed to a bottom of said slot, provide a stylus ejecting force; and
a holder, having one end fastened to said elastic apparatus, and an inserting part for inserting a stylus.

8. The stylus ejection mechanism of claim 7, wherein said elastic apparatus further comprises a fastening structure.

9. The stylus ejection mechanism of claim 8, wherein said elastic apparatus is clamped or bolted to said bottom of said slot through said fastening structure.

10. The stylus ejection mechanism of claim 7, wherein said elastic apparatus is a spring providing pushing forces.

11. The stylus ejection mechanism of claim 7, wherein said elastic apparatus is a metal elastic apparatus providing pushing forces.

12. The stylus ejection mechanism of claim 7, wherein said elastic apparatus and said holder can be formed together as a whole by plastic casting.

13. The stylus ejection mechanism of claim 7, wherein said slot further comprises a switch for clamping said stylus, whereby said stylus is prevented from slipping out.
